(19) United States
(12) Patent Application Publication
(10) Pub. No.: US 2009/0088525 A1
(43) Pub. Date: Apr. 2, 2009

(54) Compositions Containing a Polyorganosiloxane Having One or More Piperidinyl Functions as a Protectant for Surfaces

(76) Inventors: Bingham Scott Jaynes, New City, NY (US); Harald Chrobaczek, Augsburg (DE)

Correspondence Address: JoAnn Villamizar;Ciba Corporation/Patent Department, 540 White Plains Road, P.O. Box 2005, Tarrytown, NY, 10591, US

(21) Appl. No.: 11/922,659

(22) PCT Filed: Jun. 14, 2006
(86) PCT No.: PCT/EP2006/063172

§ 371 Date: Nov. 10, 2008

Related U.S. Application Data
(60) Provisional application No. 60/693,696, filed on Jun. 24, 2005.

(51) Int. Cl. C09D 183/04; C08G 77/388

(52) U.S. Cl. 524/838; 525/474

(57) ABSTRACT

Cleaning/protectant compositions containing a polyorganosiloxane having one or more piperidinyl functions are useful in the protection of vinyl, plastic and other hard surfaces from environmental exposure such as UV- or oxidation-induced damage.

The present invention relates to cleaning/protectant compositions containing a polyorganosiloxane having one or more piperidinyl functions and their use in the protection of vinyl and other surfaces from environmental exposure such as UV- or oxidation-induced damage.

### BACKGROUND

This invention concerns the use of compositions containing a polyorganosiloxane having one or more piperidinyl groups in order to protect vinyl and other surfaces from environmental exposure such as UV-induced or oxidation-induced damage.

The use of silicon-based compositions has already been suggested for the treatment of laundry made of textile fibers. More specifically, the addition of amino-silicones to washing or rinsing compositions has been suggested, e.g. in U.S. Pat. No. 4,585,563; WO 92/07927; WO 98/39401 and EP-A-150872, in order to produce a softening effect. Other perceptible effects, such as anti-static, anti-wrinkling and ease-of-ironing can also result. The described amino-functions, which are linked to a silicon atom by means of an alkylene bridge containing from 1 to 6 carbon atoms, are of the —N(X)(Y) type, where the symbols X and Y independently represent H, a C₁-C₃ alkyl radical, a phenyl radical, a C₅-C₆ cycloalkyl radical, a —C₁-C₆-alkylene-NH₂ radical, or a —COR radical, where R is a monovalent hydrocarbon radical. Amino-modified silicones, including those modified with piperidinyl functionality are also disclosed as fabric softening agents in U.S. Pat. Nos. 6,800,602; 6,815,412; 6,825,683; 6,831,055; and in FR 2,824,841.

Polyvinyl chloride (PVC) protectants that have been commercialized over the years often comprise solutions or emulsions of polydimethylsiloxanes and various other additives such as those described in U.S. Pat. Nos. 3,956,174 and 5,183,845. The products are commonly used for automotive interior and exterior PVC (vinyl) parts as well as household vinyl or other plastic products to improve the appearance by providing gloss, and to protect the surface by improving durability and water repellency. While these products provide temporary improvements to vinyl and plastic surfaces, testing has shown that single applications of these products do not effectively protect vinyl from extended weathering and exposure to UV light.

Efforts have been made to manufacture vinyl products that are resistant to the deleterious effects of UV light by incorporating additives such as hindered amine light stabilizers (HALS) directly into the vinyl resin during the manufacturing process. For example, the use of HALS in the manufacture of a variety of organic polymers is described in U.S. Pat. Nos. 4,472,547; 4,547,537, and 5,241,067. However, these additives do not afford the long-term protection to the substrate that is needed for vinyl products that are constantly exposed to UV light such as upholstery for automobiles and boats, vinyl car tops, etc.

Efforts have also been made to incorporate HALS molecules directly into vinyl protectant formulations in order to provide an additional amount of protectant each time the surface is treated. Polysiloxane emulsion compositions containing HALS components are described in WO 96/21696. While these compositions provide suitable temporary protection, the HALS is easily removed from the surface by wiping or wear so that the protective effect is lost. The HALS molecules have also been found to migrate downward into the substrate away from the surface requiring protection, and thus diminishing the protective power of the remaining siloxane coating.

### SUMMARY OF THE INVENTION

Surprisingly it has now been found that a polyorganosiloxane having one or more piperidinyl groups bound to the polyorganosiloxane can provide durable protection against weathering and exposure to UV light to hard surfaces such as vinyl and plastic surfaces.

Accordingly, one aspect of the present invention is a protectant and cleaning composition for hard surfaces such as vinyl and plastic surfaces, which contains a polyorganosiloxane having one or more piperidinyl groups bound to the polyorganosiloxane.

Another aspect of the present invention is a method of protection of a hard surface, which comprises contacting said hard surface with an effective amount of a protectant formulation containing a polyorganosiloxane having one or more piperidinyl groups bound to the polyorganosiloxane.

### EXAMPLE 1

### Detailed Description of the Invention

One aspect of the present invention is a protectant and surface cleaning composition for hard surfaces, which contains a polyorganosiloxane having one or more piperidinyl groups bound to the polyorganosiloxane. Said piperidinyl groups may be bonded directly or indirectly to the siloxane backbone or to a terminal group.

In one embodiment the treatment composition comprises at least one polyorganosiloxane, which includes at least one group of the formula:

(R)ₐ(X)_{b}RₚSi(O)[3−(a+b)]/2 (I)

wherein
the R groups can be the same or different, and represent monovalent linear or branched C₁-C₄ alkyl, phenyl or 3,3,3-trifluoro propyl radicals;
the X groups can be the same or different, and represent monovalent linear or branched hydroxyalkyl groups, hydroxyl groups, or C₁-C₃ alkoxy radicals;
Rₚ represents one or more sterically hindered piperidinyl groups selected from
   the radicals of formula (II):

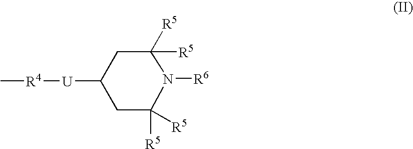

in which
   R⁴ is a divalent hydrocarbon radical selected from:
      linear or branched alkylene radicals with between 2 and 18 carbon atoms;
      alkylene-carbonyl radicals whose linear or branched alkylene stems have between 2 and 20 carbon atoms;
      alkylene-cyclohexylene radicals whose linear or branched stems have between 2 and 12 carbon atoms, and whose cyclohexylene stem includes an OH group and, optionally, 1 or 2 alkyl radicals with between 1 to 4 carbon atoms;
      radicals according to the formula —R⁷—O—R⁷— wherein the identical or varying R⁷ radicals represent alkylene radicals with 1 to 12 carbon atoms;
         radicals according to the formula —R⁷—O—R⁷— in which the R⁷ radicals have the aforementioned values, and one or both are substituted with one or two —OH groups;
         radicals according to the formula —R⁷—COO—R⁷— in which the R⁷ radicals have the aforementioned values;
         radicals according to the formula —R⁸—O—CO—R⁹— in which the identical or different R⁸ and R⁹ radicals represent alkylene radicals with between 2 and 12 carbon atoms, and where the radical R⁸ or R⁹ can optionally be substituted with a hydroxyl radical;
         U represents —O— or —NR¹⁰—, R¹⁰ being a radical selected from a hydrogen atom, a linear or branched alkyl radical with between 1 and 6 carbon atoms, or a divalent radical, according to the following formula:

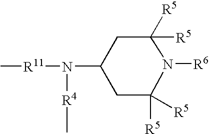

in which R⁴ is as defined above, R⁵ and R⁶ have the following values, and R¹¹ represents a linear or branched divalent alkylene radical with between 1 and 12 carbon atoms, and where R¹¹ is connected to an —NR¹⁰— radical, and the R⁴ is connected to a silicon atom;
radicals R⁵, whose values can be identical or different, are linear or branched alkyl radicals having between 1 and 3 carbon atoms or phenyl radicals;
radical R⁶ represents either hydrogen, a radical R⁵ or O^{};
and the remaining formula radicals (III):

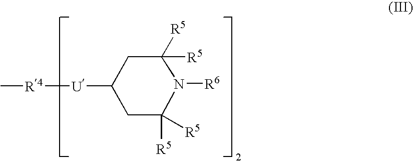

where R¹⁴ is a trivalent radical having the following formula:

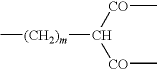

where m is between 2 and 20, or a trivalent radical having the following formula:

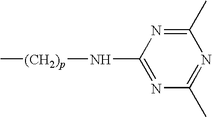

where p is between 2 and 20;
U′ represents —O— or NR¹², where R¹² is hydrogen or a linear or branched alkyl radical with between 1 and 6 carbon atoms;
R⁵ and R⁶ have the same values as those indicated in Formula (II), wherein;
a is 0, 1, or 2;
b is 0, 1, or 2;
and where “a+b” can not be more than 2.

Polyorganosiloxanes with sterically hindered amino functions as shown in Formula (I) can be obtained according to the process described in EP-A-659930.

These can have a dynamic viscosity ranging from approximately 100 mPa·s to 200,000 mPa·s at 25° C. as measured for example with a Brookfield viscometer.

In one embodiment, said polyorganosiloxane with sterically hindered amino functions is a linear, cyclic or branched polyorganosiloxane according to formula (I′):

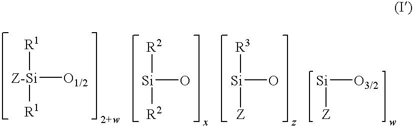

wherein:
(1) the values of Z, identical or not, represent R¹, and/or Rₚ;
(2) the values of R¹, R² and R³, identical and/or not, represent a monovalent hydrocarbon radical selected from a range of linear or branched alkyl radicals with between 1 and 4 carbon atoms, linear or branched alkoxy radicals with between 1 and 4 carbon atoms, phenyl radicals, hydroxyl, methoxy and methyl radicals;
(3) the value of Rₚ, be it for identical or different functional groups, represents a group with one or more sterically hindered piperidinyl functions, selected from those in Formulas (II) or (III) above; and
(4) included are between 10 and 450 Si-containing units without Rₚ groups;
   and from 1 to 10 Si-containing units with Rₚ-type groupings;
   0≦w≦10, and 8<(x+y)<448.

R¹, R² and R³ preferably represent hydroxyl, methoxy or methyl radicals.

The polysiloxane of formula (1′) preferably includes between 5 and 250 Si-containing units without Rₚ groups and preferably 1 to 10 Si-containing units with Rₚ-type groupings.

The second objective of this invention is to define a method for improving the properties of a composition designed for protecting hard surfaces, such as vinyl or other plastic surfaces, by adding to the composition at least one polyorganosiloxane with sterically hindered amino functions, according to Formulas (I) or (I′), in sufficient quantity to provide a UV protection effect.

Such compositions can be in various forms, but are generally emulsions of organopolysiloxanes, or silicone fluids, in water. The organopolysiloxanes are preferably dimethylsiloxane polymers, linear in nature. The dimethylpolysiloxane fluids suitable for use have a viscosity range of 10 to 100,000 centistokes. Preferably, the viscosity of the silicone fluid used should be in the range of from about 100 to 10,000 centistokes. By substitution of some of the methyl groups with other organic or organofunctional groups, other organopolysiloxanes can be produced, and are suitable for use in this composition. For example, amino-modified polysiloxanes may be used.

The silicone fluid or mixture of fluids is typically used in the form of a water emulsion, where water represents from about 30% to 99% of the total weight of formulation. Such silicone fluids and emulsions of these in water are described in detail in U.S. Pat. Nos. 3,956,174 and 5,183,845, both incorporated herein by reference.

The silicone fluid of the protectant composition is comprised at least in part of piperidinyl (HALS) substituted polysiloxane polymers as described in this invention. The HALS substituted polymer can represent any portion from 0.1% to 100% by weight of the total amount of polysiloxane present in the protectant formulation, so long as the amount of HALS-containing component is sufficient to provide protection to the surface being treated. The preferred amount of HALS-substituted polymer is 10-100% by weight with respect to total amount of polysiloxane, and the most preferred amount is 40-100% by weight.

Additional components of the protectant formulation may include a variety of materials familiar to those skilled in the art. These additives may include, but are not limited to: water, organic solvents, emulsifiers (to provide stability to the emulsion), other surfactants and wetting agents (to aid wetting and facilitate breaking of the emulsion upon application), glycerin, ethylene glycol, propylene glycol, other glycols, dyes, fragrances, foam inhibitors, UV absorbers, stabilizers, preservatives, rust inhibitors rust inhibitors, other adjuvant materials, and mixtures thereof.

The method of use of the protectant compositions of this invention comprises application of the composition onto a hard surface to be protected by spraying, wiping, or other similar means.

The composition may also be first applied to a nonwoven fabric, wiping tool, or other implement suitable for the delivery of the composition onto the surface. The material is then allowed to thoroughly wet and coat the surface for some period of time. Any excess material may be wiped off if necessary, and the surface may be buffed to a shine if desired.

Preferably the protectant composition comprises at least one polyorganosiloxane of the formula (1) or (1′) of this invention.

The term “hard surface” includes both rigid and flexible materials. Especially preferred are materials that have surfaces that are susceptible to UV or oxidative damage and that may be treated with a siloxane emulsion without harm to the surface. These include plastics (e.g. vinyl/PVC, Plexiglas/PMMA, other acrylics, styrenics, polyolefins, nylon, polyurethane, etc.), rubber, silicones and untreated wood; latex or oil-based paints and coatings (e.g. stains, polyurethanes, varnishes, shellacs) on various hard surfaces, especially wood; melamines, composites, paper-based surfaces such as wallpaper, and natural and synthetic leathers.

The following examples describe certain embodiments of this invention, but the invention is not limited thereto. It should be understood that numerous changes to the disclosed embodiments can be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight unless otherwise indicated.

### EXAMPLE 1

Protectant Composition: A HALS-modified polysiloxane (C.A.S. registration #171543-65-0) with a nitrogen content of 0.38% was added at a level of 15% by weight to water. The approximate structure of the siloxane is shown below:

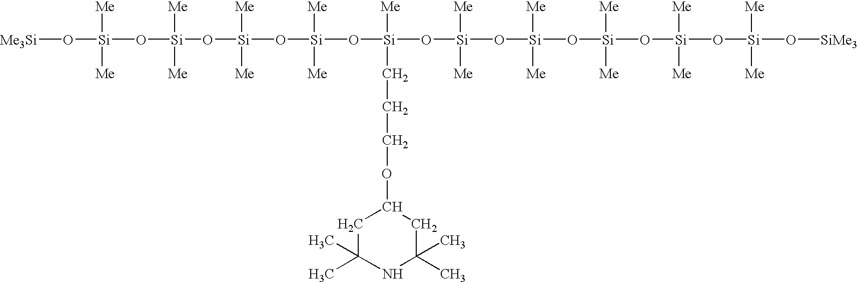

An emulsifier with a hydrophilic/lipophilic balance (HLB) of 12 was added at a level of 6% and the mixture was emulsified with a high-speed mixer. An appropriate amount of acid was added while stirring until the mixture became clear. Such an emulsion is commercially available as ULTRATEX® FMW from Ciba Specialty Chemicals.

### EXAMPLE 2

Method of Treatment of vinyl: A silicone microemulsion in water comprising 15% of the HALS-substituted polydimethylsiloxane polymer from Example 1 was applied to three 7 cm×14 cm pieces of automotive dashboard vinyl by adding 1 ml of the protectant formulation to the surface and wiping the material onto the vinyl with a cotton terry cloth for 15 seconds. Three vinyl pieces were treated in the same manner using a commercial protectant formulation. The treated vinyl swatches as well as a set of three untreated vinyl swatches were then placed in an Atlas Ci4000 Xenon Weatherometer and exposed to UV light using an interior automotive accelerated weathering program as specified in SAE-J-1885.

The vinyl surface was evaluated for degradation by first washing it thoroughly with a detergent solution, rinsing with deionized water and then air-drying. The vinyl was then analyzed using a Thermo Electron Avatar 370 FTIR spectrometer equipped with a Smart Orbit ATR accessory fitted with a diamond crystal. An absorption spectrum was recorded for each cleaned and dried vinyl sample, and the ratio of peak heights for the absorbance at ˜1250 cm⁻¹ and 1098 cm⁻¹ was calculated. The decrease in this peak ratio corresponds to the degradation of the polyurethane surface coating on the vinyl swatch. Thus, lower values of this ratio indicate a higher degree of degradation.

Degradation values for the treated and control vinyl swatches are presented in the table below, for a UV exposure time of 48 hr total (˜90 kJ exposure energy). Samples treated with the emulsion from Example 1 had reduced degradation levels versus the control or those treated with the commercial protectant.

| Vinyl Treatment | Peak ratio, T = 0 | Peak ratio, T = 48 hrs |
|---|---|---|
| None | 1.49 | 0.65 |
| Commercial Protectant | 1.53 | 0.65 |
| Emulsion of Example 1 | 1.47 | 0.72 |

### EXAMPLE 3

Method of Treatment of vinyl. Vinyl swatches were treated in the same manner as in Example 2, except that the swatches were retreated with protectant after 16 and 32 hours of exposure in the Weatherometer. After a total of 48 hours of exposure (90 kJ of energy), the samples were washed, rinsed and dried, and analyzed by the IR method described in Example 2.

The peak ratios in the table below indicate that material treated with the emulsion from Example 1 again exhibited the lowest degree of degradation of the three samples tested:

| Vinyl Treatment | Peak ratio, T = 0 | Peak ratio, T = 48 hrs |
|---|---|---|
| None | 1.49 | 0.72 |
| Commercial Protectant | 1.49 | 0.75 |
| Emulsion of Example 1 | 1.50 | 0.76 |

1. A composition for protecting hard surfaces, which comprises a polyorganosiloxane having one or more piperidinyl groups bound to the polyorganosiloxane.

2. A composition according to claim 1, which comprises at least one polyorganosiloxane, which includes at least one group of the formula:
(R)ₐ(X)_{b}RₚSi(O)[3−(a+b)]/2 (I)
wherein
the R groups can be the same or different, and represent monovalent linear or branched C₁-C₄ alkyl, phenyl or 3,3,3-trifluoro propyl radicals;
the X groups can be the same or different, and represent monovalent linear or branched hydroxyalkyl groups, hydroxyl groups, or C₁-C₃ alkoxy radicals;
Rₚ represents one or more sterically hindered piperidinyl groups selected from
the radicals of formula (II): 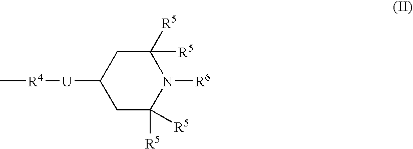
in which
R⁴ is a divalent hydrocarbon radical selected from:
linear or branched alkylene radicals with between 2 and 18 carbon atoms;
alkylene-carbonyl radicals whose linear or branched alkylene stems have between 2 and 20 carbon atoms;
alkylene-cyclohexylene radicals whose linear or branched stems have between 2 and 12 carbon atoms, and whose cyclohexylene stem includes an OH group and, optionally, 1 or 2 alkyl radicals with between 1 to 4 carbon atoms;
radicals according to the formula —R⁷—O—R⁷— wherein the identical or varying R⁷ radicals represent alkylene radicals with 1 to 12 carbon atoms;
radicals according to the formula —R⁷—O—R⁷— in which the R⁷ radicals have the aforementioned values, and one or both are substituted with one or two —OH groups;
radicals according to the formula —R⁷—COO—R⁷— in which the R⁷ radicals have the aforementioned values;
radicals according to the formula —R⁸—O—CO—R⁹— in which the identical or different R⁸ and R⁹ radicals represent alkylene radicals with between 2 and 12 carbon atoms, and where the radical R⁸ or R⁹ can optionally be substituted with a hydroxyl radical;
U represents —O— or —NR¹⁰—, R¹⁰ being a radical selected from a hydrogen atom, a linear or branched alkyl radical with between 1 and 6 carbon atoms, or a divalent radical, according to the following formula: 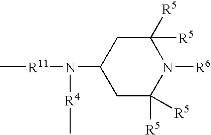
in which R⁴ is as defined above, R⁵ and R⁶ have the following values, and R¹¹ represents a linear or branched divalent alkylene radical with between 1 and 12 carbon atoms, and where R¹¹ is connected to an —NR¹⁰— radical, and the R⁴ is connected to a silicon atom;
radicals R⁵, whose values can be identical or different, are linear or branched alkyl radicals having between 1 and 3 carbon atoms or phenyl radicals;
radical R⁶ represents either hydrogen, a radical R⁵ or O^{};
and the remaining formula radicals (III): 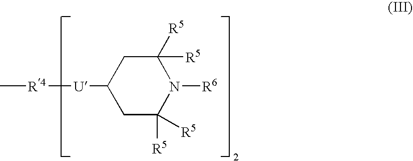
where R′⁴ is a trivalent radical having the following formula: 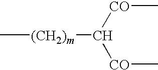
where m is between 2 and 20, or a trivalent radical having the following formula: 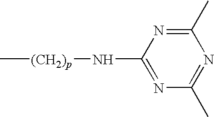
where p is between 2 and 20;
U′ represents —O— or NR¹², where R¹² is hydrogen or a linear or branched alkyl radical with between 1 and 6 carbon atoms;
R⁵ and R⁶ have the same values as those indicated in Formula (II), wherein;
a is 0, 1, or 2;
b is 0, 1, or 2;
and where “a+b” cannot be more than 2.

3. A composition according to claim 2, in which the polyorganosiloxane with sterically hindered amino functions is a linear, cyclic or branched polyorganosiloxane according to formula (I′): 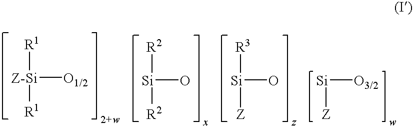
wherein:
(1) the values of Z, identical or not, represent R¹, and/or Rₚ;
(2) the values of R¹, R² and R³, identical and/or not, represent a monovalent hydrocarbon radical selected from a range of linear or branched alkyl radicals with between 1 and 4 carbon atoms, linear or branched alkoxy radicals with between 1 and 4 carbon atoms, phenyl radicals, hydroxyl, methoxyl and methyl radicals;
(3) the value of Rₚ, be it for identical or different functional groups, represents a group with one or more sterically hindered piperidinyl functions, selected from those in Formulas (II) or (III) above; and
(4) included are between 10 and 450 Si-containing units without Rₚ groups;
and from 1 to 10 Si-containing units with Rₚ-type groupings;
0≦w≦10, and 8<(x+y)<448.

4. A composition according to claim 3, wherein R¹, R² and R³ represent hydroxyl, methoxy or methyl radicals.

5. A composition according to claim 3, which has between 5 and 250 Si-containing units without Rₚ groups and 1 to 10 Si-containing units with Rₚ-type groupings.

6. A composition according to claim 1, wherein the polyorganosiloxane having one or more piperidinyl groups bound to the polyorganosiloxane is of the formula

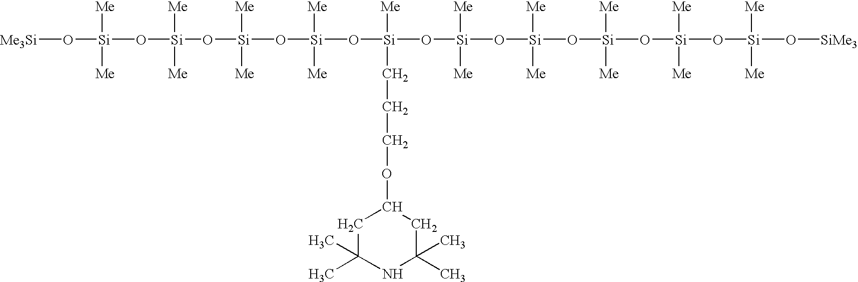

7. A composition according to claim 1, wherein the polyorganosiloxane having one or more piperidinyl groups bound to the polyorganosiloxane comprises from 0.1% to 100% by weight, preferably 10 to 100% by weight, of the total amount of polysiloxane present in the protectant formulation.

8. A composition according to claim 1, which is in the form of an aqueous emulsion.

9. A composition according to claim 1, which comprises further additives.

10. A composition according to claim 9, wherein the further additives comprise water, organic solvents, emulsifiers, other surfactants and wetting agents (to aid wetting and facilitate breaking of the emulsion upon application), glycerin, ethylene glycol, propylene glycol, other glycols, dyes, fragrances, foam inhibitors, UV absorbers, stabilizers, preservatives, rust inhibitors, other adjuvant materials, and mixtures thereof.

11. (canceled)

12. A method of protecting a hard surface, which comprises contacting said hard surface with a protectant composition containing an effective amount of a polyorganosiloxane having one or more piperidinyl groups bound to the polyorganosiloxane.

13. A method according to claim 12, which comprises contacting said hard surface with an effective protectant amount of a polyorganosiloxane of the formula (1)
(R)ₐ(X)_{b}RₚSi(O)[3−(a+b)]/2 (I)
wherein
the R groups can be the same or different, and represent monovalent linear or branched C₁-C₄ alkyl, phenyl or 3,3,3-trifluoro propyl radicals;
the X groups can be the same or different, and represent monovalent linear or branched hydroxyalkyl groups, hydroxyl groups, or C₁-C₃ alkoxy radicals;
Rₚ represents one or more sterically hindered piperidinyl groups selected from
the radicals of formula (II): 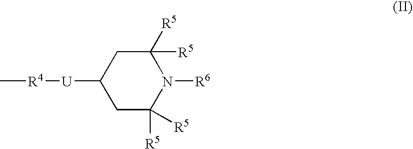
in which
R⁴ is a divalent hydrocarbon radical selected from:
linear or branched alkylene radicals with between 2 and 18 carbon atoms;
alkylene-carbonyl radicals whose linear or branched alkylene stems have between 2 and 20 carbon atoms;
alkylene-cyclohexylene radicals whose linear or branched stems have between 2 and 12 carbon atoms, and whose cyclohexylene stem includes an OH group and, optionally, 1 or 2 alkyl radicals with between 1 to 4 carbon atoms;
radicals according to the formula —R⁷—O—R⁷— wherein the identical or varying R⁷ radicals represent alkylene radicals with 1 to 12 carbon atoms;
radicals according to the formula —R⁷—O—R⁷— in which the R⁷ radicals have the aforementioned values, and one or both are substituted with one or two —OH groups;
radicals according to the formula —R⁷— COO—R⁷— in which the R⁷ radicals have the aforementioned values;
radicals according to the formula —R⁸ —O—CO—R⁹— in which the identical or different R⁸ and R⁹ radicals represent alkylene radicals with between 2 and 12 carbon atoms, and where the radical R⁸ or R⁹ can optionally be substituted with a hydroxyl radical;
U represents —O— or —NR¹⁰—, R¹⁰ being a radical selected from a hydrogen atom, a linear or branched alkyl radical with between 1 and 6 carbon atoms, or a divalent radical, according to the following formula: 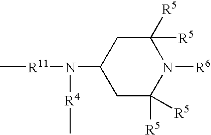
in which R⁴ is as defined above, R⁵ and R⁶ have the following values, and R¹¹ represents a linear or branched divalent alkylene radical with between 1 and 12 carbon atoms, and where R¹¹ is connected to an —NR¹⁰— radical, and the R⁴ is connected to a silicon atom;
radicals R⁵, whose values can be identical or different, are linear or branched alkyl radicals having between 1 and 3 carbon atoms or phenyl radicals;
radical R⁶ represents either hydrogen, a radical R⁵ or O^{};
and the remaining formula radicals (III): 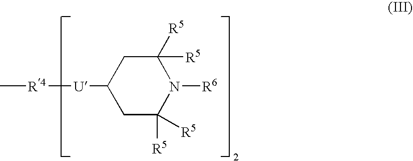
where R′⁴ is a trivalent radical having the following formula: 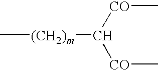
where m is between 2 and 20, or a trivalent radical having the following formula: 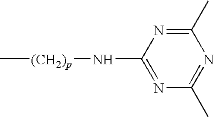
where p is between 2 and 20;
U′ represents —O— or NR¹², where R¹² is hydrogen or a linear or branched alkyl radical with between 1 and 6 carbon atoms;
R⁵ and R⁶ have the same values as those indicated in Formula (II), wherein;
a is 0, 1, or 2;
b is 0, 1, or 2;
and where “a+b” cannot be more than 2.

14. A method according to claim 12, which comprises contacting said hard surface with an effective protectant amount of a polyorganosiloxane of the formula (1′) 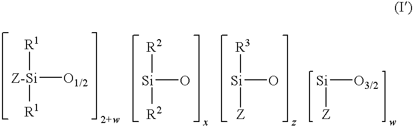
wherein:
(5) the values of Z, identical or not, represent R¹, and/or Rₚ;
(6) the values of R¹, R² and R³, identical and/or not, represent a monovalent hydrocarbon radical selected from a range of linear or branched alkyl radicals with between 1 and 4 carbon atoms, linear or branched alkoxy radicals with between 1 and 4 carbon atoms, Phenyl radicals, hydroxyl, methoxyl and methyl radicals;
(7) the value of Rₚ, be it for identical or different functional groups, represents a group with one or more sterically hindered piperidinyl functions, selected from those in Formulas (II) or (III) above; and
(8) included are between 10 and 450 Si-containing units without Rₚ groups;
and from 1 to 10 Si-containing units with Rₚ-type groupings; 0≦w≦10, and 8<(x+y)<448.

15. A method of protecting a hard surface according to claim 12, wherein said surface is susceptible to UV or oxidative damage and may be treated with a siloxane emulsion without harm to the surface.

16. A method of protecting a hard surface according to claim 12, wherein said surface is selected from plastics, rubber, silicones and untreated wood; painted and coated hard surfaces including wood; melamines and composites, paper-based surfaces, and natural and synthetic leathers.
